(19) United States
(12) Patent Application Publication
(10) Pub. No.: US 2015/0177744 A1
(43) Pub. Date: Jun. 25, 2015

(54) STEAM-HOT WATER MIXTURE GENERATOR

(71) Applicant: CNSC. Inc., Busan (KR)

(72) Inventor: Sun-Woo CHOI, Busan (KR)

(73) Assignee: CNSC. Inc., Busan (KR)

(21) Appl. No.: 14/514,951

(22) Filed: Oct. 15, 2014

(30) Foreign Application Priority Data
Dec. 23, 2013 (KR) 10-2013-0161100

(51) Int. Cl. G05D 11/13; B08B 3/02

(52) U.S. Cl. CPC G05D 11/132; B08B 3/02; B08B 2230/01

(57) ABSTRACT

A steam-hot water mixture generator is provided. The steam-hot water mixture generator generates steam together with an adequate amount of hot water and sprays them, thereby improving washing capability and preventing the discharge of only steam or an excessive amount of hot water, and produces a steam and hot water mixture in an optimum mixing ratio and sprays the mixture, thereby maximizing the washing capability

### BACKGROUND OF THE INVENTION

1. Field of the Invention

The present invention relates, in general, to a steam-hot water mixture generator and, more particularly, to a steam-hot water mixture generator which generates steam together with an adequate amount of hot water and sprays them, thereby improving washing capability and preventing the discharge of only steam or an excessive amount of hot water.

2. Description of the Related Art

Generally, a steam generator configured to generate steam by heating water using a heating apparatus such as an electric heater or a boiler has been used in a variety of applications, since it can efficiently clean an object with a small quantity of water while providing excellent sterilization and ironing effects.

For instance, such a steam generator representatively includes a steam car wash, a steam washer for washing e.g. industrial or household medical appliances requiring both sterilization and washing, a steam iron for ironing clothes using steam, and the like. In addition, a steam generator includes a steam generator for skin care, a steam shower, a cooking steamer, and the like.

Such a conventional steam generator applied in various fields includes a pressure container in which water is contained, a heater configured to heat water contained in the pressure container, a sprayer configured to spray steam using high pressure created in the pressure container by a heat source of the heater, a thermometer, a manometer, and the like.

Most of steam generators are designed to spray only steam through a sprayer. However, particularly in the case of steam washer, it does not sufficiently clean a target object only with the steam.

Particularly, when washing a radiator panel of an air conditioner, the radiator panel of metal cannot be sufficiently washed only with steam, so it is required to separately carry out water-spraying at the same time in order to compensate for this.

### DOCUMENT OF RELATED ART

(Patent Document) Korean Unexamined Patent Publication No. 10-2008-0085127 (published on Sep. 23, 2008)

### SUMMARY OF THE INVENTION

Accordingly, the present invention has been made keeping in mind the above problems occurring in the related art, and an object of the present invention is to provide a steam-hot water mixture generator which can produce a steam and hot water mixture in an optimum mixing ratio and spray the mixture, thereby maximizing the washing capability.

In order to achieve the above object, according to one aspect of the present invention, there is provided a steam-hot water mixture generator including: a pressure container storing water therein; a steam outlet disposed on an upper portion of the pressure container and configured to allow steam generated in the pressure container to be discharged therethrough with a steam pressure; a hot water outlet disposed on a lower portion of the pressure container and configured to allow hot water in the pressure container to be discharged therethrough with the steam pressure and a weight of the hot water; a mixture outlet at which a steam pipe connected to the steam outlet and a hot water pipe connected to the hot water outlet are combined and which is configured to mix steam and hot water in a specific mass ratio into a steam-hot water mixture and discharge the mixture; a first solenoid valve disposed between the steam outlet and the mixture outlet and configured to shut off or release the supply of steam; and a second solenoid valve disposed between the hot water outlet and the mixture outlet and configured to shut off or release the supply of hot water.

Preferably, when it is intended to discharge the steam-hot water mixture through the mixture outlet, the first and second solenoid valves are opened; when it is intended to discharge only steam, the first solenoid valve is opened and the second solenoid valve is closed; and when it is intended to discharge only hot water, the first solenoid valve is closed and the second solenoid valve is opened, wherein a mass ratio of steam and hot water in the steam-hot water mixture is 2:8.

Preferably, when ‘L’ is a total height of the pressure container, ‘a’ is a height of steam contained in the pressure container, ‘b’ is a height of hot water contained in the pressure container, and ‘c’ is a height from the bottom to the mixture outlet, the following correlations are satisfied:
L=a+b; a:b=7:15; and c=0.55 L.

Preferably, when ‘e’ is an inner diameter of a first socket connected to the steam outlet on the outside of the pressure container, ‘f’ is an inner diameter of the steam outlet, ‘g’ is an inner diameter of a second socket connected to the hot water outlet on the outside of the pressure container, ‘h’ is an inner diameter of the hot water outlet, ‘i’ is an inner diameter of a steam pipe of the mixture outlet, and ‘j’ is an inner diameter of a hot water pipe of the mixture outlet, the following correlations are satisfied:
e=g; f=h; f=e/2; h=g/2; i=f/2; and j=h/2.

According to the present invention, the steam outlet and the hot water outlet are respectively provided on the upper and lower portions of the pressure container, and the mixture outlet at which the steam pipe connected to the steam outlet and the hot water pipe connected to the hot water outlet are combined is provided, so that steam is sprayed together with an adequate amount of hot water, increasing the washing capability.

Further, according to the present invention, the configuration is made such that a first condition on: a ratio of steam and hot water contained in the pressure container in the sense of respective heights thereof relative to a total height of the pressure container; and a height of the mixture outlet relative to the total height of the pressure container, and a second condition on the measurements of pipes around the pressure container are satisfied at the same time, thereby preventing the discharge of only steam or an excessive amount of hot water.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a perspective view showing a steam-hot water mixture generator according to an embodiment of the present invention;

FIG. 2 is a conceptual view of a pressure container; and

FIG. 3 is a circuit diagram of the steam-hot water mixture generator according to an embodiment of the present invention.

### DETAILED DESCRIPTION OF THE INVENTION

Hereinbelow, preferred embodiments of the present invention will be described in detail with reference to the accompanying drawings. In assigning reference numerals to respective elements in the drawings, it is noted that, wherever possible, the same reference numerals will be used throughout the drawings and the description to refer to the same or like parts. In the following description, it is to be noted that, when the functions of conventional elements and the detailed description of elements related with the present invention may make the gist of the present invention unclear, a detailed description of those elements will be omitted. It is of course that the technical scope of the present invention is not limited to the disclosed preferred embodiments, which, however, may be modified and implemented into various forms by persons skilled in the art.

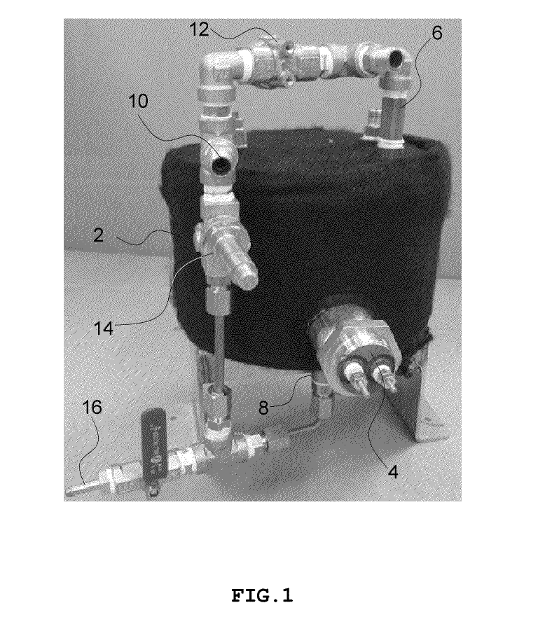

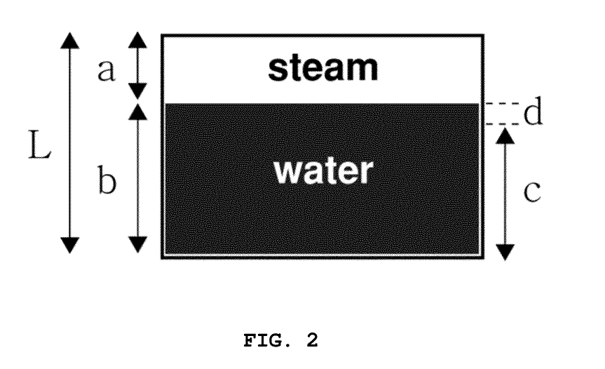

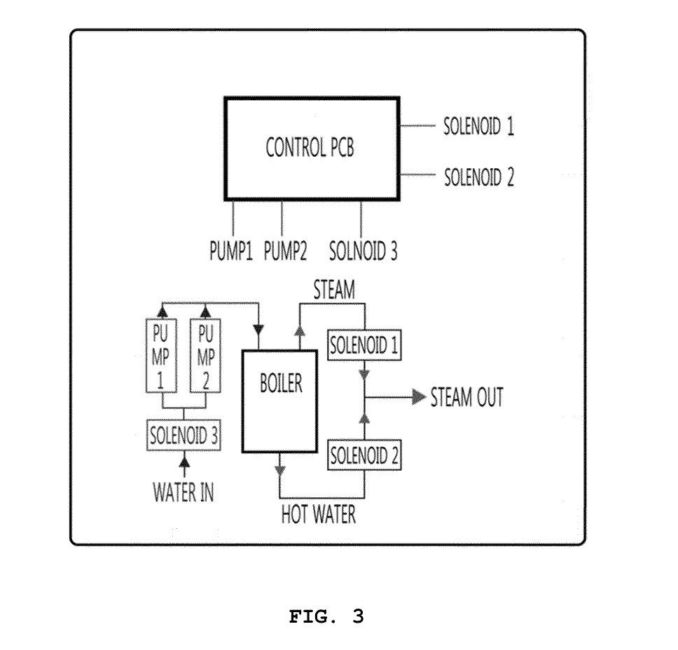

FIG. 1 is a perspective view showing a steam-hot water mixture generator according to an embodiment of the present invention, FIG. 2 is a conceptual view of a pressure container, and FIG. 3 is a circuit diagram of the steam-hot water mixture generator according to an embodiment of the present invention.

Referring to FIGS. 1 to 3, the steam-hot water mixture generator includes a pressure container 2, a heater holder 4, a steam outlet 6, a hot water outlet 8, a mixture outlet 10, a first solenoid valve 12, a second solenoid valve 14, and a drain 16.

The pressure container 2 stores water therein. When water is injected, water is pumped into a boiler by means of first and second pumps via a third solenoid valve. In the boiler, water is heated into hot water (about 150° C. to 170° C.), and some of the water is changed into steam in the heating process (see FIG. 3).

The heater holder 4 holds a heater for heating water, and the heater is provided in the boiler.

The steam outlet 6 is an outlet that is positioned on an upper surface of the pressure container 2 and through which steam generated in the pressure container 2 is discharged and sprayed to the outside under steam pressure. The upper surface of the pressure container is provided with a first socket via which the steam outlet 6 is connected to the pressure container 2.

The hot water outlet 8 is an outlet that is positioned at a lower portion of the pressure container 2 and through which hot water in the pressure container 2 is discharged and sprayed to the outside by the action of steam pressure and of weight of hot water. A second socket is provided on the pressure container at a position where the hot water outlet 8 is connected to the pressure container 2.

The mixture outlet 10 is an outlet at which a steam pipe connected to the steam outlet 6 and a hot water pipe connected to the hot water outlet 8 are combined and which is configured to mix steam and hot water in a specified mass ratio into a steam-hot water mixture and discharge the mixture. The mixture outlet is also provided with a third socket for connection between the steam pipe and the hot water pipe.

The first solenoid valve 12 is disposed between the steam outlet 6 and the mixture outlet 10 and is configured to shut off or release the supply of steam.

The second solenoid valve 14 is disposed between the hot water outlet 8 and the mixture outlet 10 and is configured to shut off or release the supply of hot water.

A third solenoid valve is also provided in order to shut off or release an inflow of water via a water inlet.

The first to third solenoid valves and the first and second pumps are electronically controlled by a controller.

The used hot water is discharged to the outside via a drain 16.

The steam-hot water generator according to the present invention may also be configured to generate and spray either of steam and hot water, as well as a steam-hot water mixture.

When it is intended to discharge the steam-hot water mixture through the mixture outlet 10, the first and second solenoid valves 12 and 14 are opened. When it is intended to discharge only steam through the mixture outlet 10, the first solenoid valve 12 is opened and the second solenoid valve 14 is closed. When it is intended to discharge only hot water through the mixture outlet 10, the first solenoid valve 12 is closed and the second solenoid valve 14 is opened. Particularly in the case of a steam washer, if steam and hot water are mixed in a specific ratio and are sprayed together, washing capability can be increased due to the presence of an adequate amount of hot water.

The steam-hot water mixture discharged from the mixture outlet 10 is to be sprayed through a steam nozzle (not shown) so as to wash a target object including a radiator of an air conditioner.

When the steam-hot water mixture is discharged from the mixture outlet 10, a mass ratio of steam and hot water in the steam-hot water mixture may preferably be 2:8. If the mass ratio of steam is less than 2, an amount of steam is excessively low, making it difficult to obtain the purpose of steam washing. If the mass ratio of steam is more than 2, an amount of hot water is low, making it difficult to obtain the purpose of simultaneous spraying of steam and hot water.

Assuming that ‘L’ is the total height of the pressure container, ‘a’ is a height of steam contained in the pressure container, ‘b’ is a height of hot water contained in the pressure container, and ‘c’ is a height from the bottom to the mixture outlet, as show in FIG. 2, the following correlations are satisfied:

L=a+b (since the total height (L) of the pressure container consists of the height (a) of the section in which steam is contained and the height (b) of the section in which hot water is contained); and,
preferably, a:b=7:15; and c=0.55 L.

Further, the mixture output may preferably be provided at a position (d) that is flush with the height of the hot water contained in the pressure container.

If the position of the mixture outlet is above the height of the hot water, a problem arises in that only the steam, rather than hot water, is discharged. In addition, if the position of the mixture outlet is below the height of hot water, another problem arises in that an amount of hot water to be discharged is sharply increased. That is, to optimize the height (or volume, a height ratio to steam, a volume ratio to steam) of hot water contained in the pressure container becomes a very important factor (referred hereinafter to as a ‘first condition’) in terms of maintaining a constant mixture ratio of steam and hot water.

Further, in order to maintain a constant mixture ratio of steam and hot water, correlations among inner diameters of: the first socket, to which the steam outlet is connected; the second socket, to which the hot water outlet is connected; the steam outlet; the hot water outlet; the steam pipe of the mixture outlet; and the hot water pipe of the mixture outlet become an important factor (referred hereinafter to as a ‘second condition’).

When ‘e’ is an inner diameter of the first socket connected to the steam outlet on the outside of the pressure container, ‘f’ is an inner diameter of the steam outlet, ‘g’ is an inner diameter of the second socket connected to the hot water outlet on the outside of the pressure container, ‘h’ is an inner diameter of the hot water outlet, ‘i’ is an inner diameter of a steam pipe of the mixture outlet, and ‘j’ is an inner diameter of a hot water pipe of the mixture outlet, the following correlations may preferably be satisfied:
e=g; f=h; f=e/2; h=g/2; i=f/2; and j=h/2.

Provided that the first condition has been satisfied, it is preferred that the inner diameters (e and g) of the first and second sockets be the same; and the inner diameters (f and h) of the steam outlet and the hot water outlet be the same. If e is not equal to g, or f is not equal to h even though the first condition is satisfied, the mixture ratio of steam and hot water cannot be set to 2:8.

Further, it is also preferred that the inner diameter (f) of the steam outlet be half the inner diameter (e) of the first socket; and the inner diameter (h) of the hot water outlet be half the inner diameter (g) of the second socket. In addition, it is also preferred that the inner diameter (i) of the steam pipe of the mixture outlet be half the inner diameter (f) of the steam outlet; and the inner diameter (j) of the hot water pipe of the mixture outlet be half the inner diameter (h) of the hot water outlet. If the conditions of f=e/2; h=g/2; i=f/2; and j=h/2 are not satisfied even though the first condition is satisfied, the mixture ratio of steam and hot water cannot be set to 2:8.

In the meantime, also in the case where the first condition is not satisfied even though the second condition is satisfied, the mixture ratio of steam and hot water cannot be set to 2:8.

Therefore, the first and second conditions should be satisfied at the same time, and thus they are considered requirements for obtaining an adequate mixture ratio of steam and hot water.

Although the embodiments of the present invention have been disclosed for illustrative purposes, those skilled in the art will appreciate that various modifications, additions and substitutions are possible, without departing from the scope and spirit of the invention. Therefore, it should be understood that the disclosed embodiments are merely illustrative forms in all aspects, rather than limited ones, so the technical scope of the present invention is not limited to the disclosed embodiments and accompanying drawings. Therefore, it should be construed that the present invention be only defined by the scope of claims, and all the equivalent technical ideas of the invention belong to the scope of the present invention.

What is claimed is:

1. A steam-hot water mixture generator comprising:
a pressure container storing water therein;
a steam outlet disposed on an upper portion of the pressure container and configured to allow steam generated in the pressure container to be discharged therethrough with a steam pressure;
a hot water outlet disposed on a lower portion of the pressure container and configured to allow hot water in the pressure container to be discharged therethrough with the steam pressure and a weight of the hot water;
a mixture outlet at which a steam pipe connected to the steam outlet and a hot water pipe connected to the hot water outlet are combined and which is configured to mix steam and hot water in a specific mass ratio into a steam-hot water mixture and discharge the mixture;
a first solenoid valve disposed between the steam outlet and the mixture outlet and configured to shut off or release the supply of steam; and
a second solenoid valve disposed between the hot water outlet and the mixture outlet and configured to shut off or release the supply of hot water,
wherein, when ‘L’ is a total height of the pressure container, ‘a’ is a height of steam contained in the pressure container, ‘b’ is a height of hot water contained in the pressure container, and ‘c’ is a height from the bottom to the mixture outlet, the following correlations are satisfied:
L=a+b; a:b=7:15; and c=0.55 L.

2. The steam-hot water mixture generator according to claim 1, wherein when it is intended to discharge the steam-hot water mixture through the mixture outlet, the first and second solenoid valves are opened; when it is intended to discharge only steam, the first solenoid valve is opened and the second solenoid valve is closed; and when it is intended to discharge only hot water, the first solenoid valve is closed and the second solenoid valve is opened, and
wherein a mass ratio of steam and hot water in the steam-hot water mixture is 2:8.

3. The steam-hot water mixture generator according to claim 1, wherein when ‘e’ is an inner diameter of a first socket connected to the steam outlet on the outside of the pressure container, ‘f’ is an inner diameter of the steam outlet, ‘g’ is an inner diameter of a second socket connected to the hot water outlet on the outside of the pressure container, ‘h’ is an inner diameter of the hot water outlet, ‘i’ is an inner diameter of a steam pipe of the mixture outlet, and ‘j’ is an inner diameter of a hot water pipe of the mixture outlet, the following correlations are satisfied:
e=g; f=h; f=e/2; h=g/2; i=f/2; and j=h/2.
